(19) United States
(12) Patent Application Publication
(10) Pub. No.: US 2008/0182597 A1
(43) Pub. Date: Jul. 31, 2008

(54) Wireless Transmitter and Receiver for Telephone and method of Using the Same

(76) Inventor: Hesham Kadada, San Francisco, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 11/747,411

(22) Filed: May 11, 2007

Related U.S. Application Data
(60) Provisional application No. 60/887,087, filed on Jan. 29, 2007.

(51) Int. Cl. H04Q 7/24

(52) U.S. Cl. 455/462

(57) ABSTRACT

The present invention provides for the addition of multiple telephone handsets and/or similar peripherals wirelessly connected to the transmitter base of a cordless telephone system. A cordless telephone transmitter and at least one wireless receiver peripheral providing cordless telephone access to an existing telephone network is presented. The present invention provides for the addition of multiple telephone handsets and/or similar peripherals wirelessly connected to the transmitter base of a cordless telephone system.

### CROSS-REFERENCES TO RELATED APPLICATIONS

This United States non-provisional patent application is based upon and claims the filing date of U.S. provisional patent application Ser. No. 60/887,087, filed 29 Jan. 2007.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

### Field of the Invention

The detailed specification set forth below relates to wireless telephone systems, and in particular to a transmitter base and at least one receiver unit to provide wireless telephone communication within a standard wall plugged environment without adding central switch boxes or external replacement wiring.

### BRIEF SUMMARY OF THE INVENTION

A cordless telephone transmitter and at least one wireless receiver peripheral providing cordless telephone access to an existing telephone network is presented. In accordance with one aspect of the invention, addition of multiple telephone handsets and/or similar peripherals wirelessly connected to the transmitter base of a cordless telephone system is described.

A primary transmitter base implements a wireless communication protocol capable of supporting simultaneous communications via a plurality of discreet communication channels. The system further supports a plurality of separate cordless handset links to traditional telephones by correspondingly connected receiver units, one per telephone handset, capable of communicating with the transmitter base via discreet communication links between each receiver unit and the transmitter unit using a separate one of the plurality of communication channels provided by the transmitter unit between the transmitter unit and each receiver unit.

Both transmitter and receiver units provide self-contained microprocessors which enhance baseband audio processing between units, control signal sequencing, and discreet identity of telephone handsets. Further both units also contain internal antenna and radio frequency transceivers within the control hierarchy of each unit's respective processor.

It is, therefore, an object to provide a cordless telephone system with wireless expansion capability for multiple peripheral telephone handset units.

It is another object to simplify the process by which a cordless telephone system can be retrofitted into an existing telephone environment comprising a wall jack to a land line and at least one telephone.

It is yet another object to provide a cordless telephone system with wireless expansion capability without the necessity of additional wiring or technical support.

It is still yet another object to provide an improved cordless telephone system with wireless expansion capability which is affordable and easily manufactured.

A further object to provide a cordless telephone system with wireless expansion capability which is self-registering between transmitter and receiver components.

Yet another object is to provide a cordless telephone system with wireless expansion capability that has components housed within self-contained units easily adapted to land line jacks or existing telephones.

Still yet another object is to define a system and method for cordless telephones with wireless expansion capability.

Other features, advantages, and objects will become apparent with reference to the following description and accompanying drawings.

### BRIEF DESCRIPTION OF DRAWINGS

FIG. 1 is a block diagram illustrating particular functional elements or processes for the transmitter unit 100 depicting an embodiment of the method and system of wireless transmitter and receiver units for a standard telephone communication system.

FIG. 2 is a block diagram illustrating particular functional elements or processes for the receiver unit 200 depicting an embodiment of the method and system of wireless transmitter and receiver units for a standard telephone communication system.

FIG. 3 is a circuitry schematic for the receiver unit 200 depicting an embodiment of the method and system of wireless transmitter and receiver units for a standard telephone communication system.

FIG. 4 is a circuitry schematic for the transmitter unit 100 depicting an embodiment of the method and system of wireless transmitter and receiver units for a standard telephone communication system.

FIG. 5 is an architectural top view of the transmitter unit 100 elements arranged within the circuit board of the transmitter to support an embodiment of the method and system of wireless transmitter and receiver units for a standard telephone communication system.

FIG. 6 is an architectural bottom view of the transmitter unit 100 elements arranged within the circuit board of the transmitter to support an embodiment of the method and system of wireless transmitter and receiver units for a standard telephone communication system.

FIG. 7 is an architectural top view of the receiver unit 200 elements arranged within the circuit board of the receiver to support an embodiment of the method and system of wireless transmitter and receiver units for a standard telephone communication system.

FIG. 8 is an architectural bottom view of the receiver unit 200 elements arranged within the circuit board of the receiver to support an embodiment of the method and system of wireless transmitter and receiver units for a standard telephone communication system.

FIG. 9 is a perspective view of the front side of the cover of the housing supporting both transmitter and receiver units depicting an embodiment of the method and system of wireless transmitter and receiver units for a standard telephone communication system.

FIG. 10 is a perspective view of the inside of the cover of the housing supporting both transmitter and receiver units depicting an embodiment of the method and system of wireless transmitter and receiver units for a standard telephone communication system.

FIG. 11 is a perspective view of the outside surface of the back cover of the housing supporting the transmitter unit depicting an embodiment of the method and system of wireless transmitter and receiver units for a standard telephone communication system.

FIG. 12 is a perspective view of the outside surface of the back cover of the housing supporting each receiver unit depicting an embodiment of the method and system of wireless transmitter and receiver units for a standard telephone communication system.

FIG. 13 is a perspective view of the inside surface of the back cover of the housing supporting the transmitter unit depicting an embodiment of the method and system of wireless transmitter and receiver units for a standard telephone communication system.

FIG. 14 is a perspective view of the inside surface of the back cover of the housing supporting each receiver unit depicting an embodiment of the method and system of wireless transmitter and receiver units for a standard telephone communication system.

FIG. 15 is a perspective view of the inside surface of the power supply cover for both of the housings supporting transmitter and receiver units depicting an embodiment of the method and system of wireless transmitter and receiver units for a standard telephone communication system.

FIG. 16 is a perspective view of the outside surface of the power supply cover for both of the housings supporting transmitter and receiver units depicting an embodiment of the method and system of wireless transmitter and receiver units for a standard telephone communication system.

### DETAILED DESCRIPTION OF THE INVENTION

While wireless transmitter and receiver units for a standard telephone communication system are susceptible to embodiment in many different forms, there are shown in the drawings and will be described in detail herein several specific embodiments, with the understanding that the present disclosure is to be considered as an exemplification of the principle of the invention and is not intended to limit the invention to embodiments illustrated.

With reference to the drawings, the method and system of a preferred mode provides a user with a primary wireless transmission base unit 100 including a connection to a single, plain old telephone service (“POTS”) telephone line jack 700. The base transmitter unit 100 communicates with at least one receiver unit 200 via a wireless communication link.

The system is further provided with the capability of adding expansion peripherals to increase the functionality of the system. The peripherals are connected to the transmission base unit 100 via further channels provided by the wireless communication protocol of the transmission base unit 100 with which additional receiver units 200 to separate telephone handsets are implemented. Thus, interface to expansion peripherals is accomplished primarily using electronic hardware which is already existent in the transmission base unit 100 and each receiver unit 200. Further connectors and interconnection components need not be included in the base unit 100, saving costs and reducing physical size of the base unit 100.

Integration of a cellular telephone interface to a cordless telephone system via wireless link not only provides convenient and cost-effective expandability, but also provides flexibility in the physical placement of the wireless telephone receiver units 200. This can be particularly important in as much as the quality of cellular coverage may vary substantially between various locations inside the user's residence or office. The optimum location for cellular telephone coverage may not be near telephone jack, which is typically required for placement of a primary base unit. By integrating the cellular cradle with a cordless telephone cordless telephone system via wireless link, the user is provided with the ability to position the cellular base transmission unit 100 in a location 1) which provides optimum reception quality, and 2) which is independent from the location of primary cordless receiver units 100 and conventional telephone jacks 700.

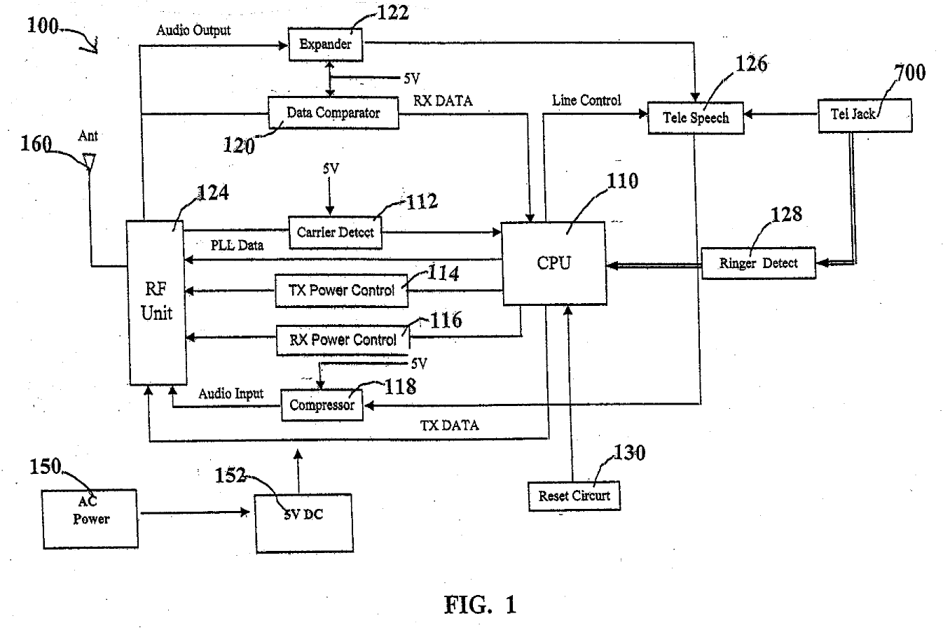

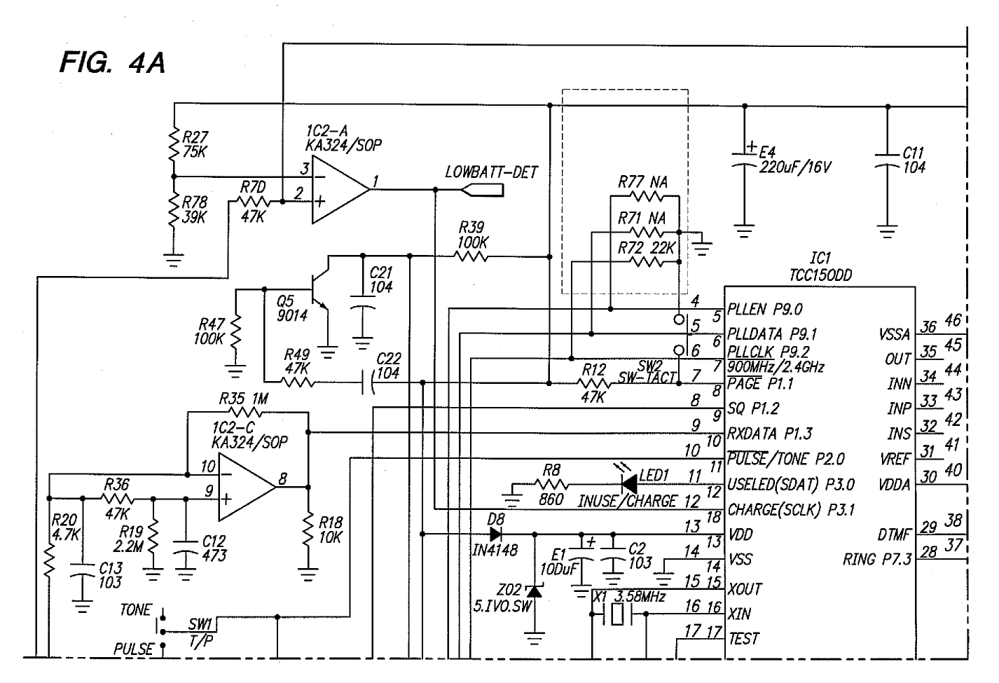

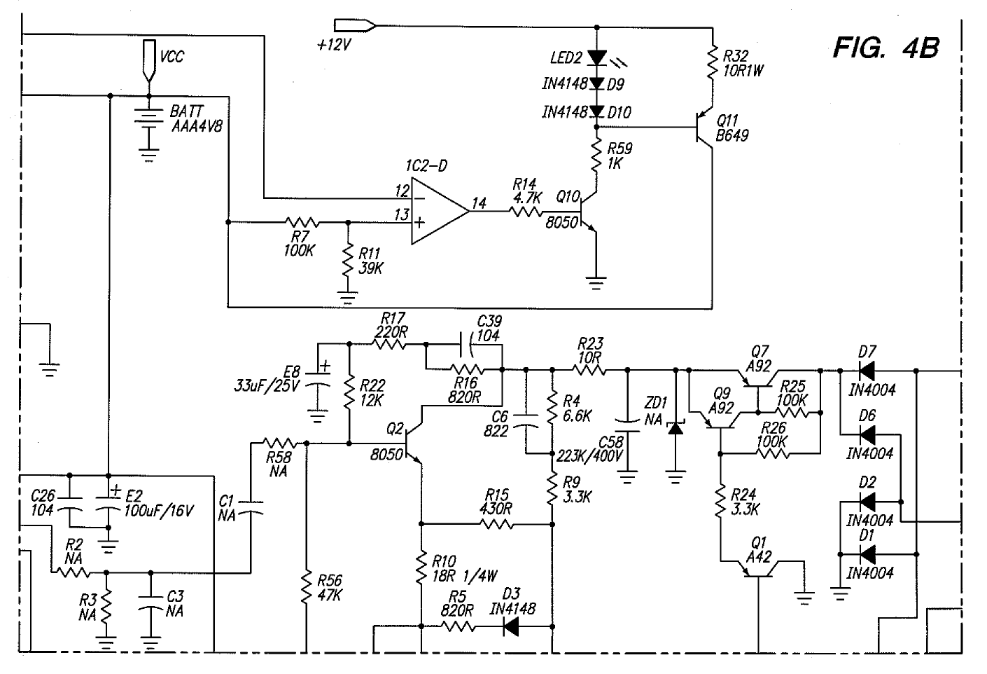

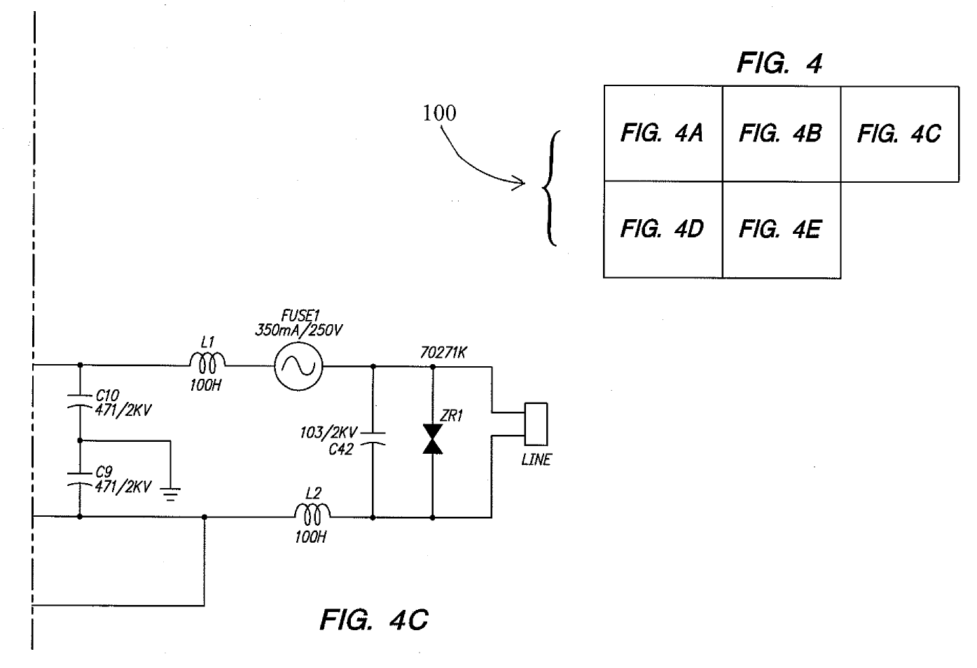

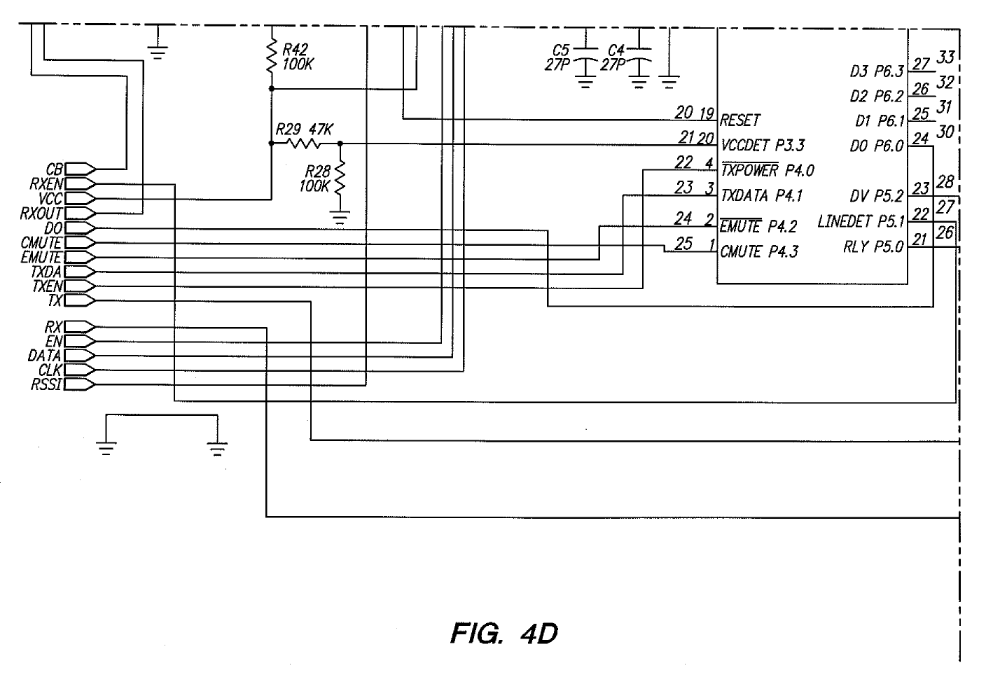

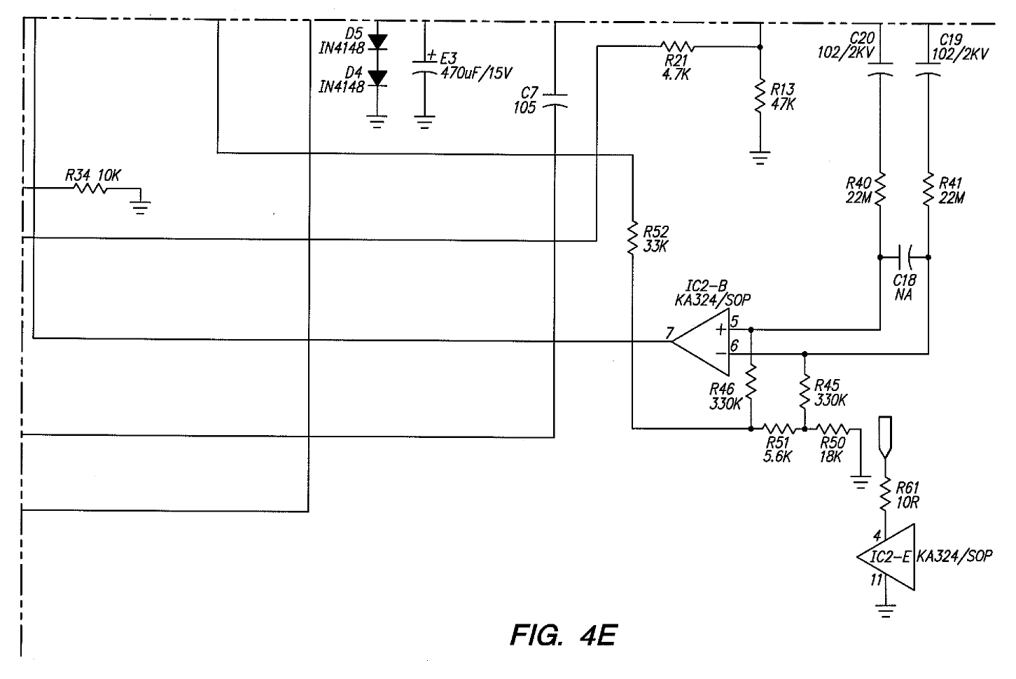

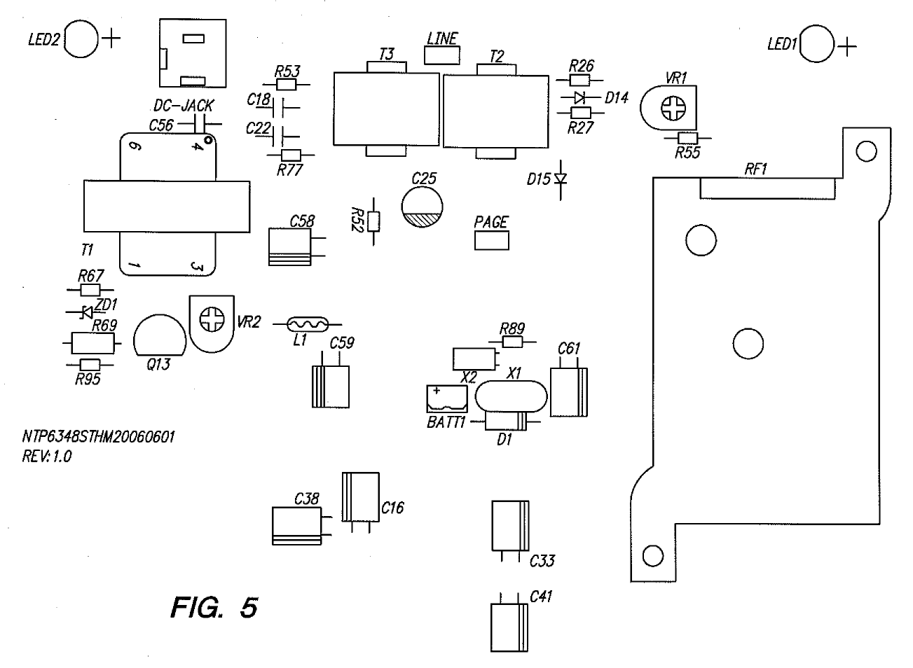

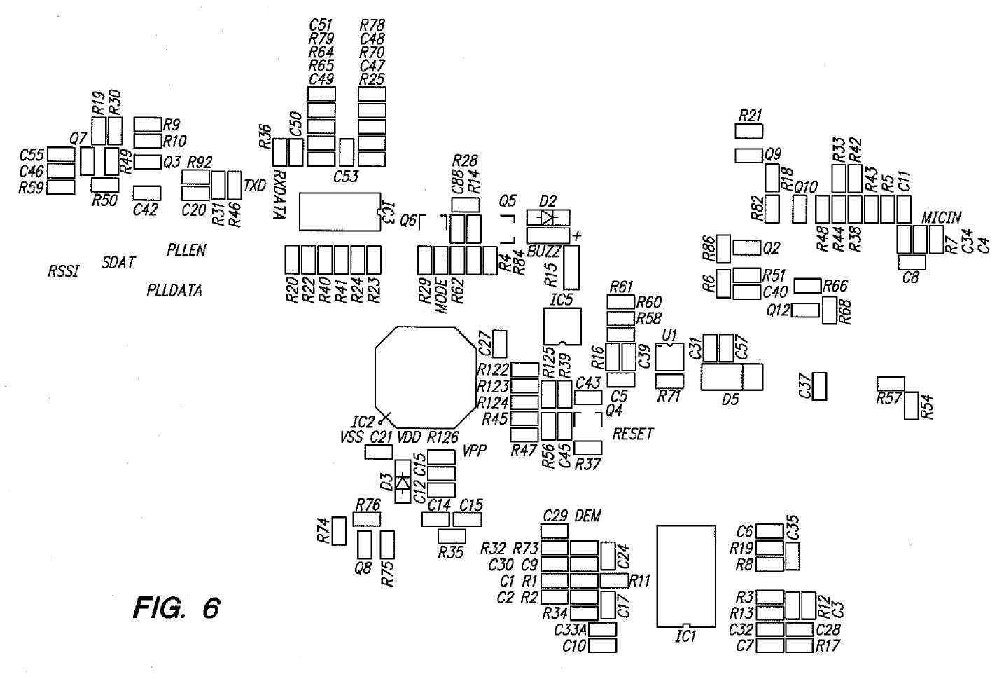

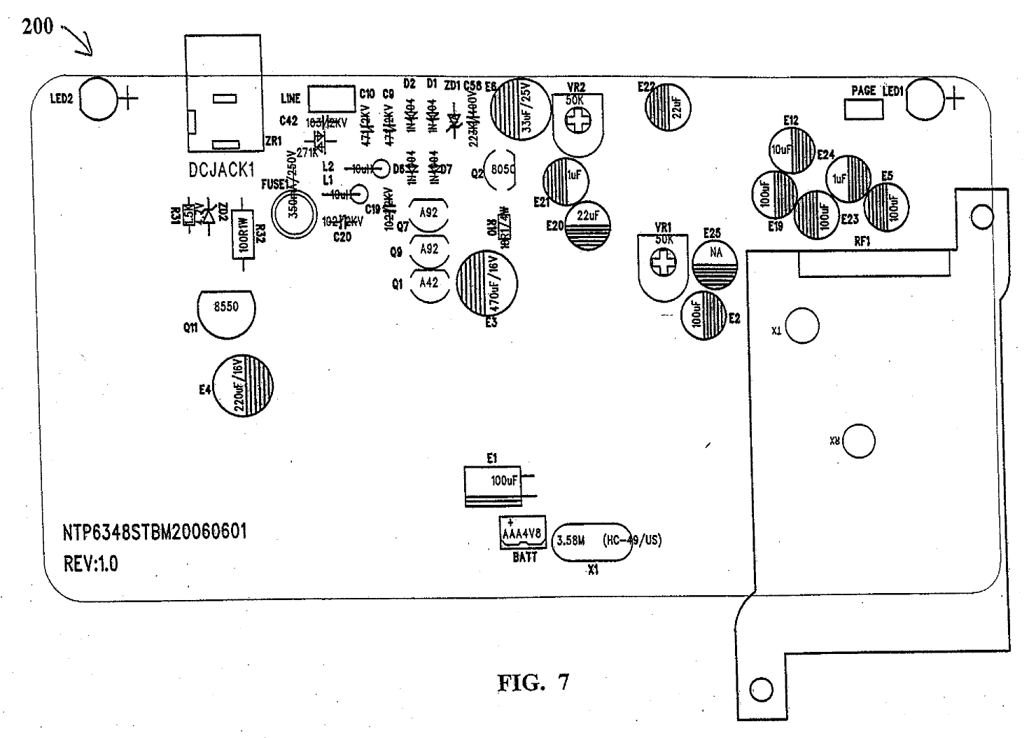

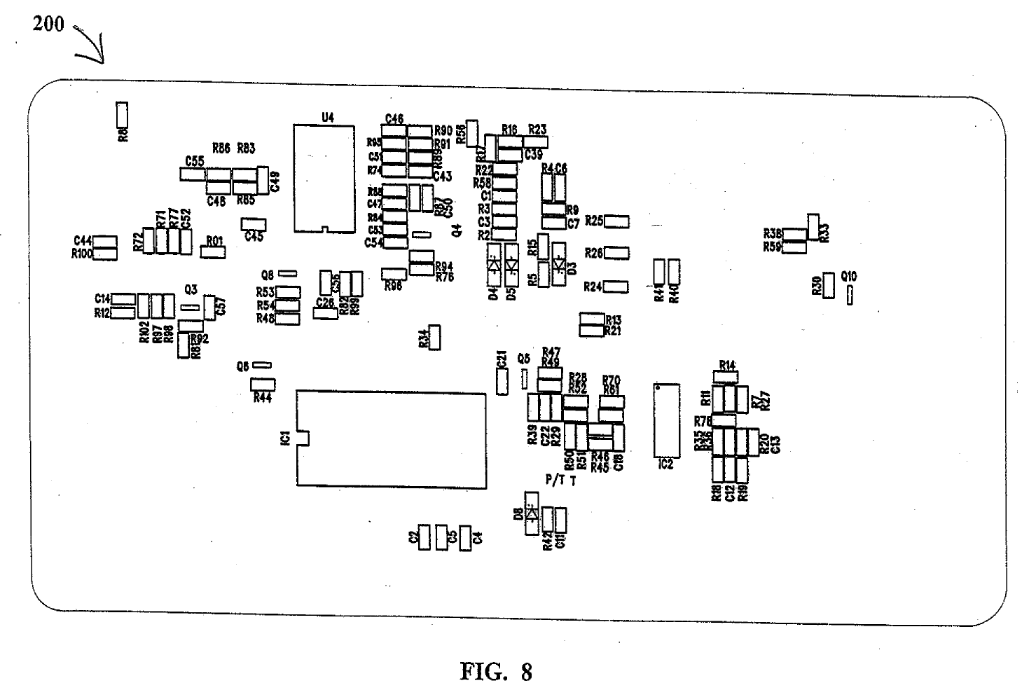

As depicted in FIGS. 1 and 4, the transmission unit 100 receives input from a single POTS telephone line a single POTS telephone line jack 700. The signal is divided between the ringer detection 128 and speech 126. The ringer is routed to the processor 110 and then to the radio frequency transceiver unit 124 via transmitter power control 114. Speech is compressed 118 to audio input to a radio frequency unit 124 and transmitted wirelessly out to the receiver unit 200 via the internally housed antenna 160.

Receiver unit 200 input communication is received by the transmission base internally housed antenna 160 and radio frequency transceiver unit 124, and is amplified 122 and/or compared 120 before the processing unit 110 sends it out through the single POTS telephone line jack 700. A reference clock signal of 40 MHZ is connected to the phase lock loop (“PLL”) input from the processor 110 and radio frequency transceiver unit 124, which generates a 200 MHZ clock for the system. Receiver unit 200 status and control is monitored through the transmission unit 100 processor 110 by discrete signal received by the internally housed antenna 160 and the carrier detector 112 and receiver power control 116.

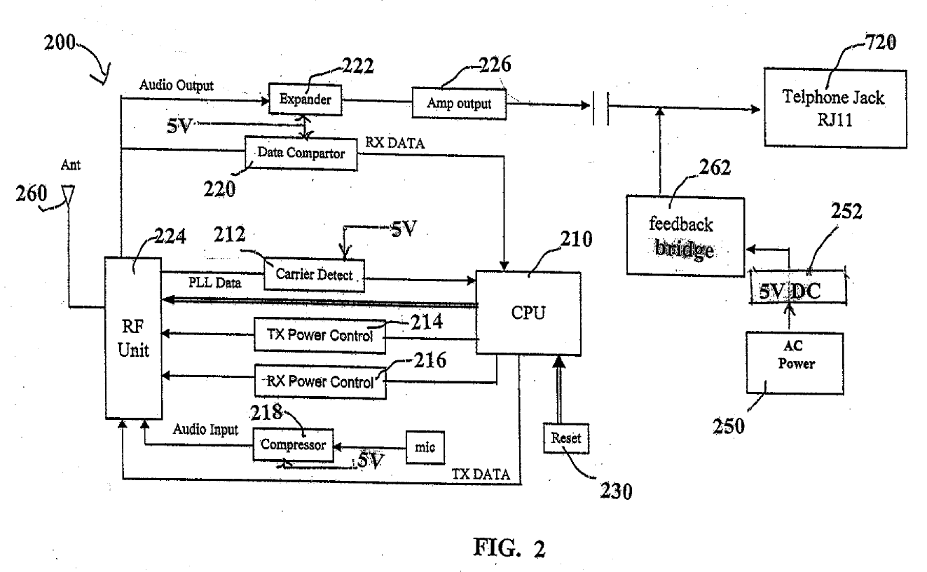

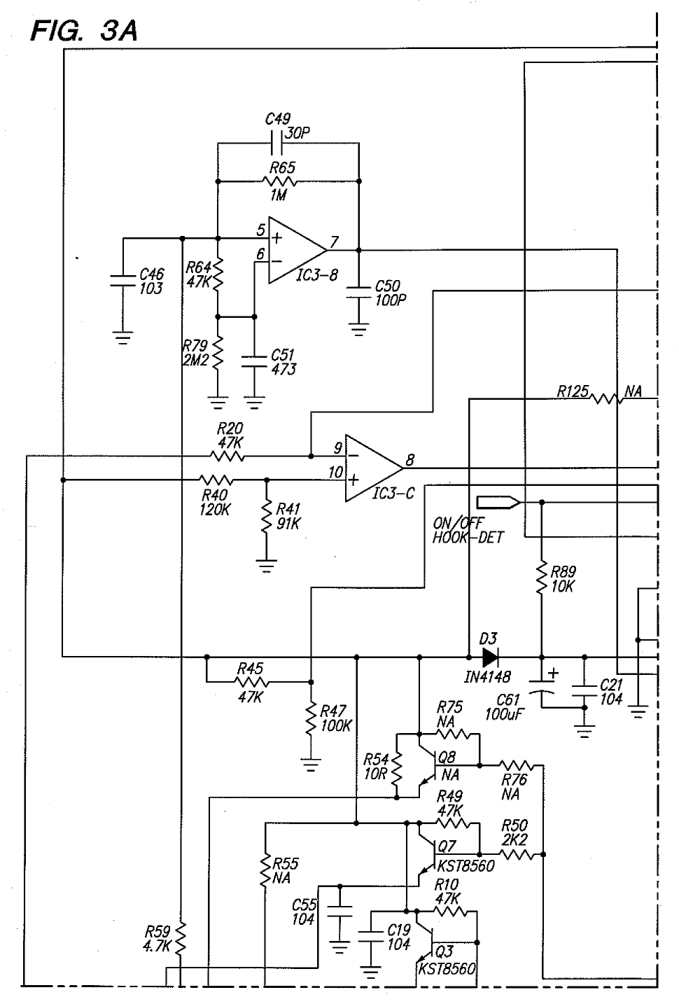

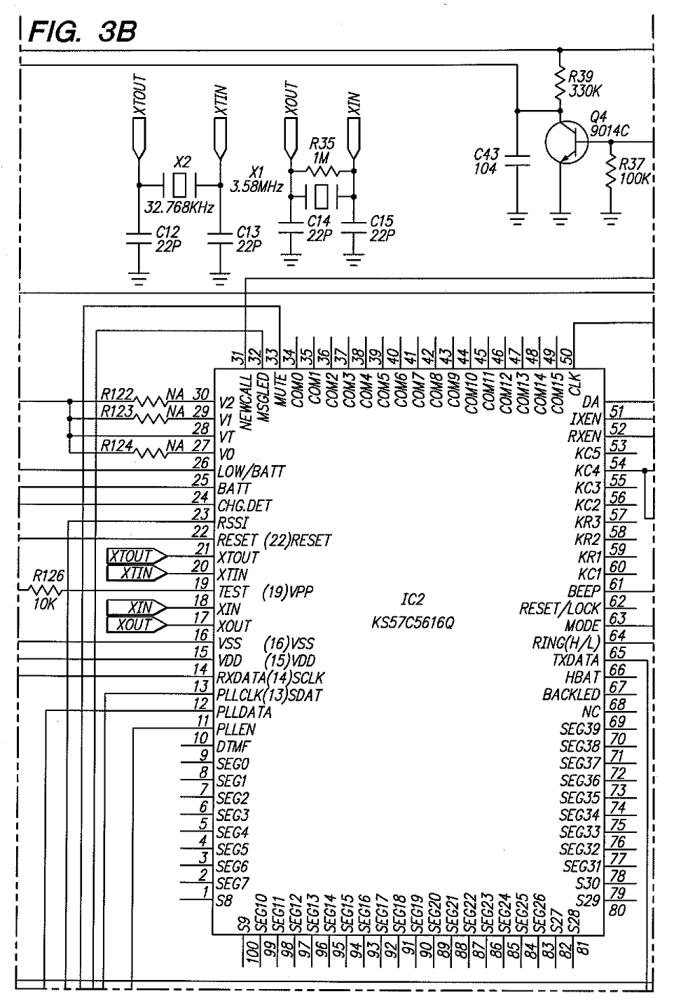

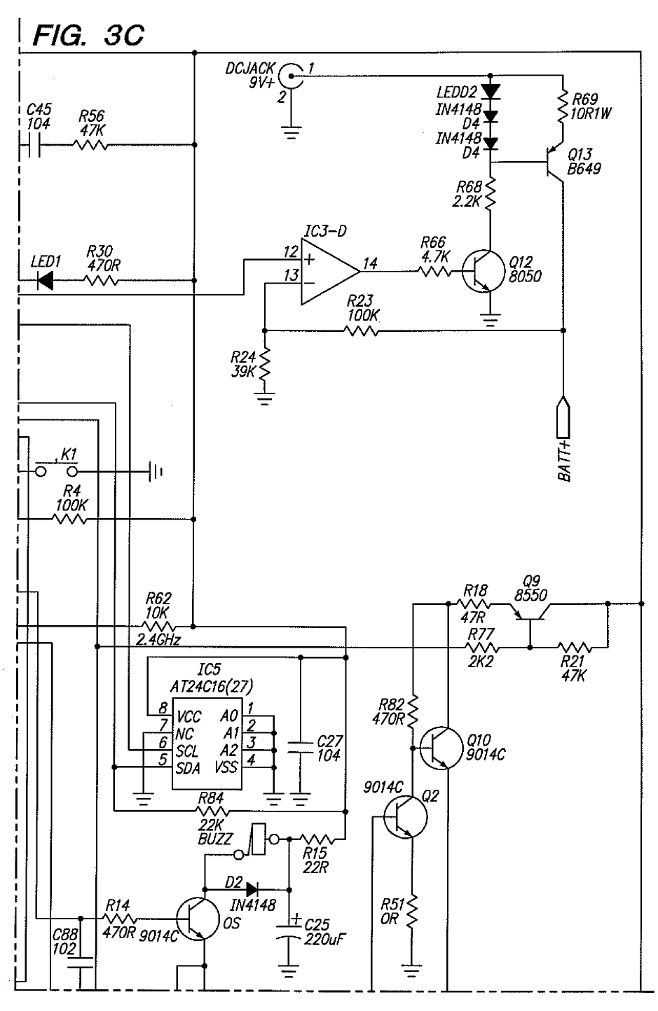

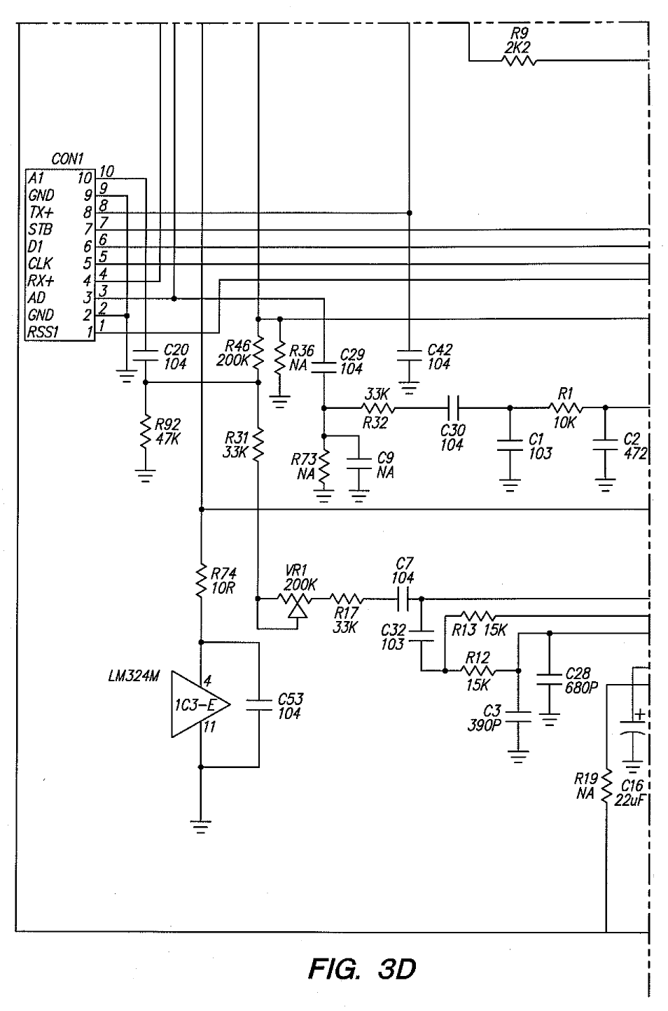

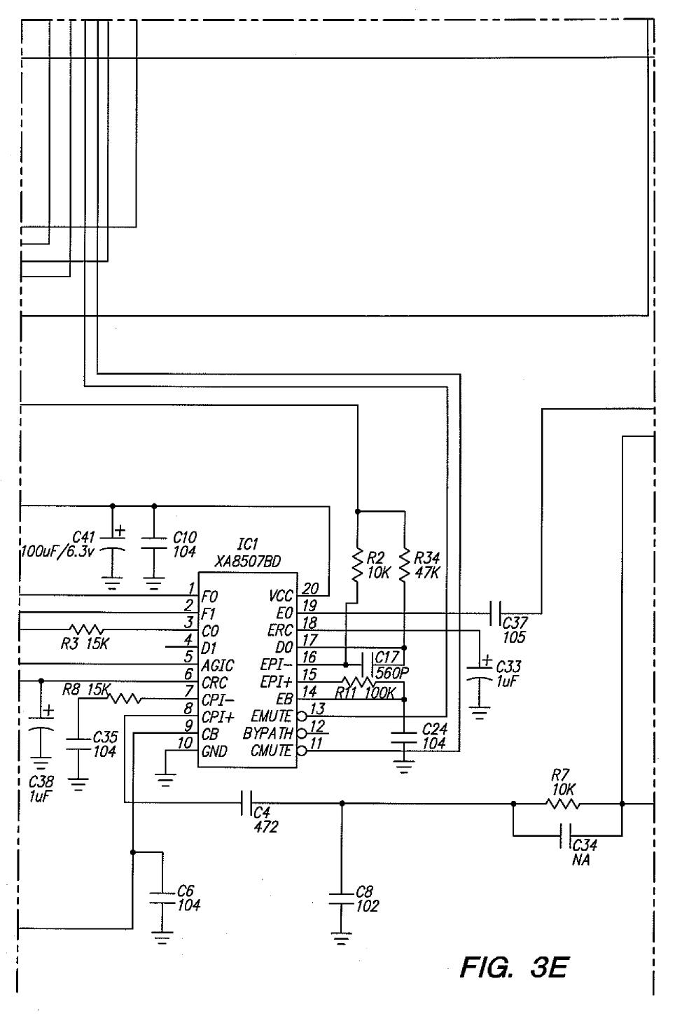

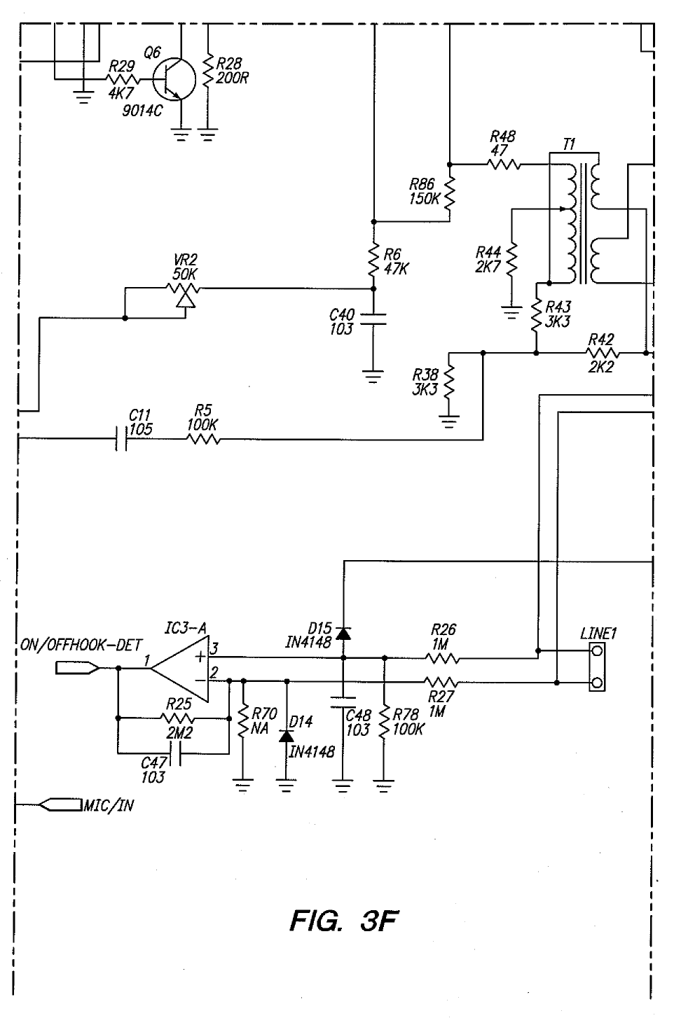

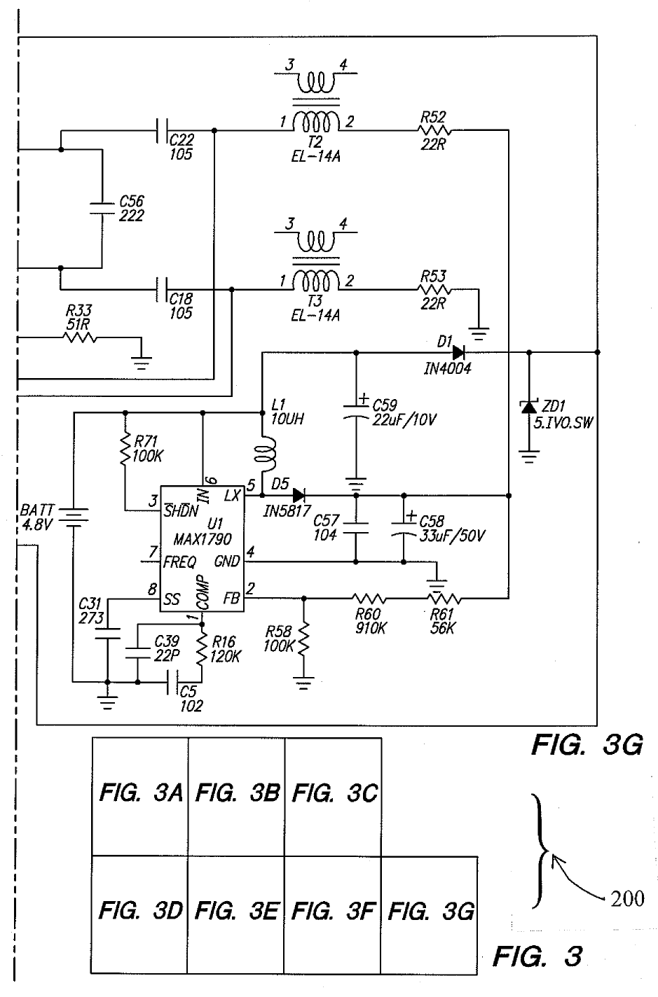

As depicted in FIGS. 2 and 3, the receiver unit 200 receives input from the transmission unit via the internally housed antenna 260 to a radio frequency transceiver unit 224. The signal is divided between an expander 222 and/or data comparator 220 and into the processor 210 and an amplifier 226 with a feedback bridge 262 to the user's earpiece receiver of the telephone handset via the RJ11 telephone jack 720. User speech input is compressed 218 to audio input to the radio frequency transceiver unit 224 and transmitted wirelessly out to the transmitter unit 100 via the internally housed antenna 260. Transmitter unit 100 status is monitored through the receiver unit 200 processor 210 by discrete signal received by the internally housed antenna 260 and the carrier detector 212, transmitter power control 214, and receiver power control 216.

The transmitter base unit 100 and each receiver unit 200 are powered by 5 volts DC from an internal rechargeable power supply 152 and 252, respectively, with an AC adapter 150 and 250, respectively, built into the units.

A reference clock signal of 40 MHZ is connected to the PLL input from the transmitter and receiver unit processor 110 and 210, respectively, and transmitter and receiver unit radio frequency transceiver unit 124 and 224, respectively, which generates a 200 MHZ clock for the transmitter unit 100 and receiver unit 200 systems. Clock frequency is controlled by the system controllers, with input clocks for each system controller block separated into two categories. One category is the peripheral blocks which is asynchronous with processor or AMBA® bus. It is, therefore, generated by a clock generator which divides PLL output with values of system controller 110 and 210 clock control registers. The second category is for blocks synchronous with the system bus. Its clock frequency is also changeable by system controller 110 and 210.

There are four operation modes in each system controller 110 and 210, namely 1) sleep, 2) doze, 3) slow, and 4) normal. In sleep mode, clocks to the processor and system bus are disabled, and the system controller clock is driven from a slow speed oscillator at approximately 32 KHz. When an interrupt is activated through the VIC, the system moves into the doze mode wherein all blocks of the system controller clock operate with low frequency oscillator at approximately 32 MHZ. In slow mode, both the system clocks and the system controller clocks are driven from the output of the crystal oscillator at 40 MHz.

The transmitter unit 100 and each receiver unit 200 have light emitting diode (“LED”) indicators and audible signal annunciators.

Each receiver unit 200 is registered to the transmitter unit 100 through initial operational sequencing by a page key input for the transmitter and each separate receiver and verified by the system via LED and audible annunciator feedback.

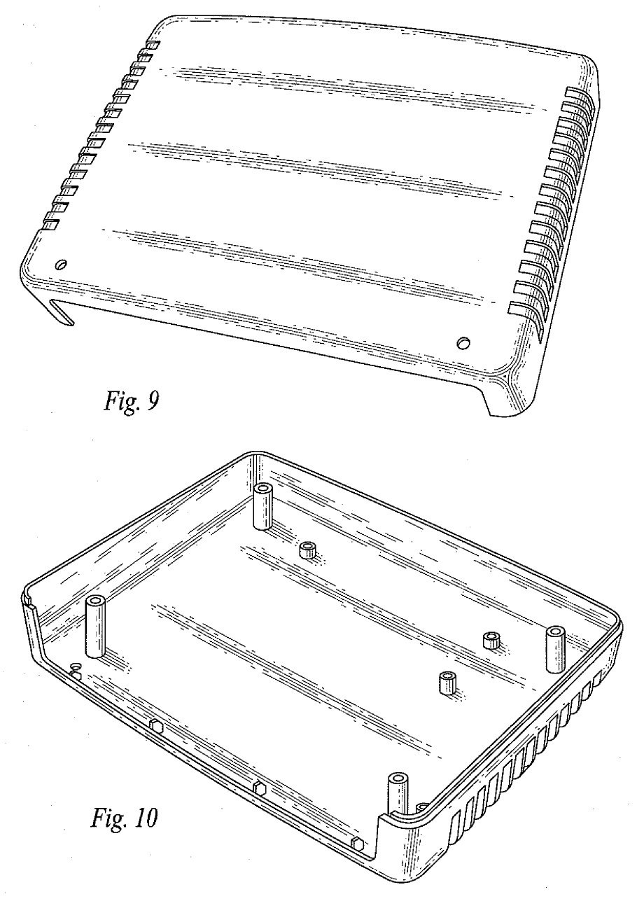

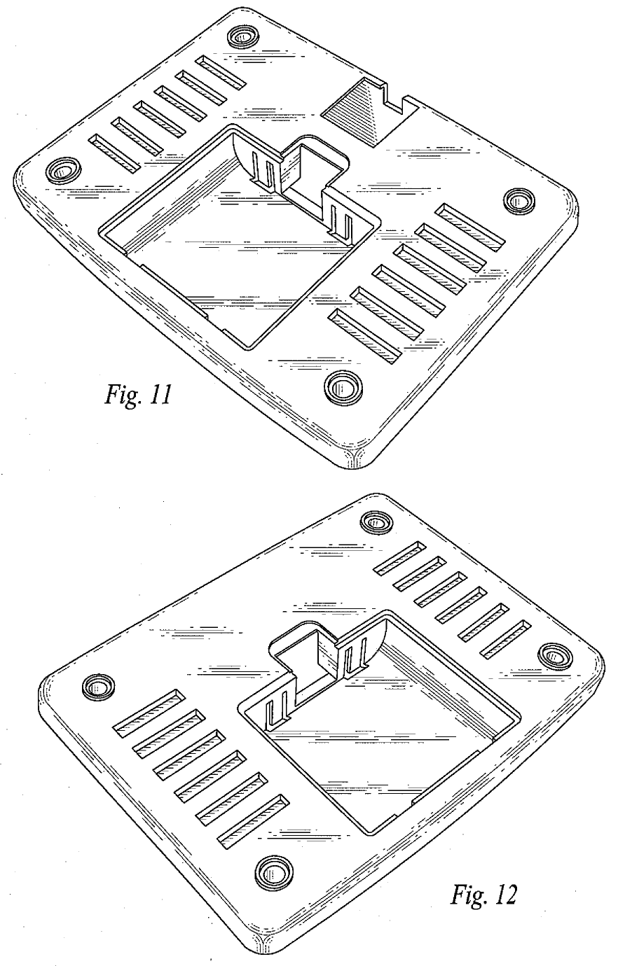

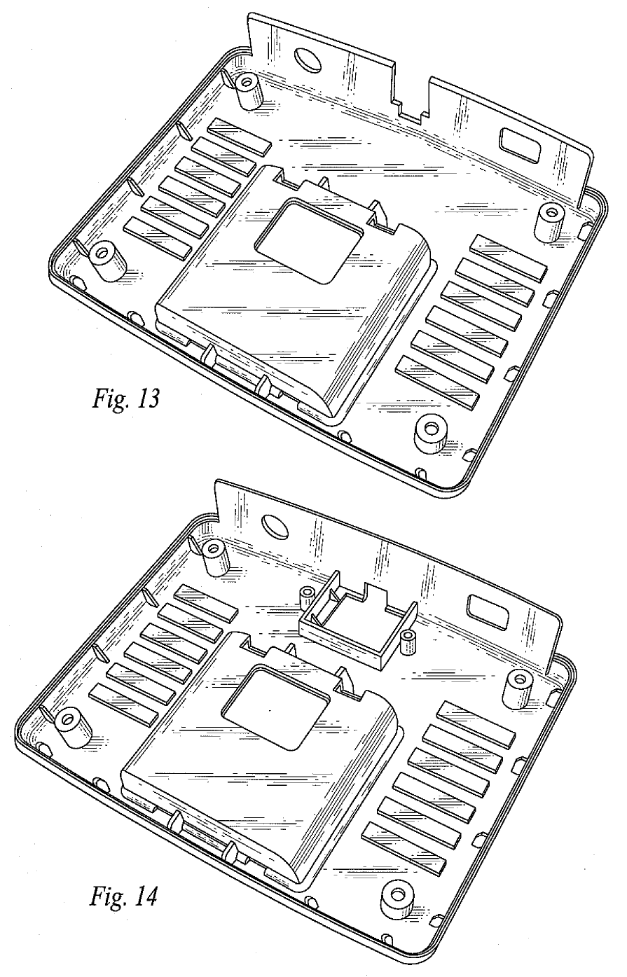

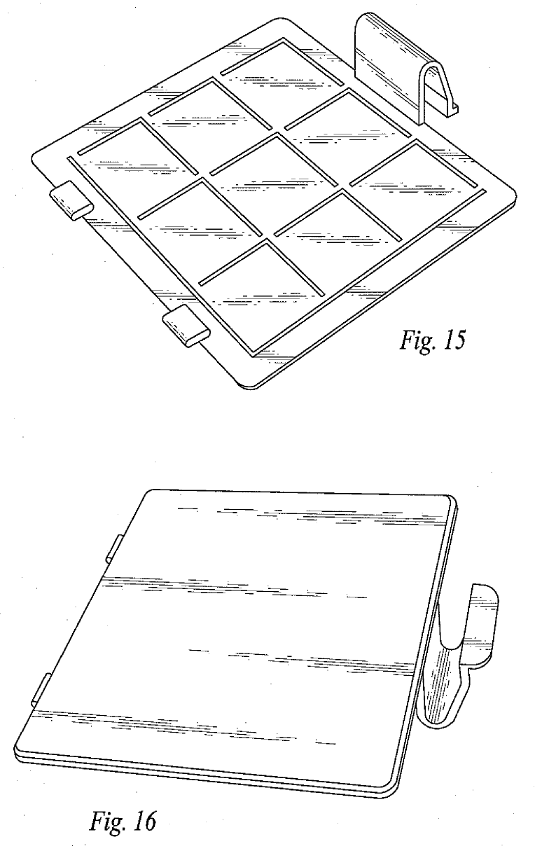

Each unit is contained within lightweight and durable housings, FIGS. 9-16, which provide means for the transmitter unit 100 to be installed vertically into a wall mounted, single POTS telephone line jack 700, and means for each receiver unit 200 to be located next to the telephone handset to which it corresponds.

The method for installation and use of the preferred embodiment is as follows:
Provide a transmitter unit 100 and at least one receiver unit 200 according to the specification described above;
Install the rechargeable battery packs 152 and 252 into each respective unit;
Charge each unites battery packs for a 15 hour period using AC adapters;
Press and hold the page key in the receiver unit. 200 until the receiver unit in-use LED indicator light is on;
Press and hold the page key in the transmitter unit 100 until the transmitter unit in-use LED indicator light is on an a search is underway;
When both receiver and transmitter unit LED lights are off and an audible beep sound is detected, registration between transmitter and receiver has been established;
Repeat the registration process for each receiver unit until all receiver units are registered with the transmitter unit;
Connect the transmitter unit to a telephone line jack;
Connect each receiver unit to a separate corded telephone;
For outgoing telephone communication, pick up a telephone and notice the receiver and transmitter units LED lights are on indicating the automatic connection between the units and a dial tone is detected, the call is placed using the telephone input, and telephone communication commences using the wireless system;
Incoming telephone communication is indicated by a ring on the receiver and receiver and transmitter unit LED lights are on indicating the automatic connection between units and the telephone is picked up to receive the communication and respond thereto using the wireless system; and
Connect the transmitter unit 100 and each receiver unit 200 to AC with AC adapters to recharge the battery packs when unit LED lights blink.

I claim:

1. A wireless telephone system comprising:
means for wireless transmission base coupled to a primary communications network for implementing a wireless communication protocol capable of supporting simultaneous communications via a plurality of wireless communications channels;
means for expansion peripherals within wireless transmission base;
means for receiver coupled to a separate standard telephone handset;
means for communication link between means for wireless transmission base and means for receiver coupled to a separate standard telephone handset, established using means for expansion peripherals and wireless communication channel unique to means for receiver coupled to a separate standard telephone handset;
whereby the wireless telephone system transmits voice information between means for receiver coupled to a separate standard telephone handset and means for wireless transmission base via means for communication link.

2. The wireless telephone system of claim 1, in which means for communication link between means for wireless transmission base and means for receiver coupled to a separate standard telephone handset comprises an analog cellular channel.

3. The wireless telephone system of claim 1, in which means for wireless transmission base further comprises:
means for dividing signal input between ringer detection and speech;
radio frequency transceiver means for transmitting via an internally housed antenna;
central processing unit microprocessor controlling scalable clock frequency with input clocks for each system controller block separated into peripheral blocks asynchronous with the microprocessor and peripheral block synchronous with the microprocessor;
rechargeable DC power supply; and
means for recharging DC power supply using AC.

4. The wireless telephone system of claim 1, in which means for receiver coupled to a separate standard telephone handset further comprises:
radio frequency transceiver means for transmitting via an internally housed antenna;
central processing unit microprocessor controlling scalable clock frequency with input clocks for each system controller block separated into peripheral blocks asynchronous with the microprocessor and peripheral block synchronous with the microprocessor;
rechargeable DC power supply; and
means for recharging DC power supply using AC.

5. The wireless telephone system of claim 1, in which means for receiver coupled to a separate standard telephone handset is registered to means for wireless transmission base through initial operational sequencing by a page key input for means for wireless transmission base and means for receiver coupled to a separate standard telephone handset, and verified by LED and audible annunciator feedback.

6. The wireless telephone system of claim 1, in which means for wireless transmission base and means for receiver coupled to a separate standard telephone are separately contained within lightweight, durable housings, wherein base means can be installed vertically into a wall mounted, single POTS telephone line jack, and each receiver means located proximate to the telephone handset to which it corresponds.

7. The wireless telephone system of claim 1, further comprising means for providing four operational controller modes.

8. The wireless telephone system of claim 7, wherein the four operational controller modes comprise modes selected from the group consisting of sleep, doze, slow and normal.

9. A wireless telephone system comprising:
at least one wireless transmission base coupled to a primary communications network for implementing a wireless communication protocol capable of supporting simultaneous communications via a plurality of wireless communications channels, the transmission base comprising means for dividing signal input between ringer detection and speech, means for expansion peripherals, radio frequency transceiver means for transmitting via an internally housed antenna, central processing unit microprocessor controlling scalable clock frequency with input clocks for each system controller block separated into peripheral blocks asynchronous with the microprocessor and peripheral block synchronous with the microprocessor, rechargeable DC power supply, and
means for recharging DC power supply using AC;
at least one receiver coupled to a separate standard telephone handset, each receiver comprising radio frequency transceiver means for transmitting via an internally housed antenna, central processing unit microprocessor controlling scalable clock frequency with input clocks for each system controller block separated into peripheral blocks asynchronous with the microprocessor and peripheral block synchronous with the microprocessor, rechargeable DC power supply, and means for recharging DC power supply using AC;
analog cellular means for communication link between each transmission base and all receivers corresponding to each such base;
whereby means each receiver is registered to a wireless transmission base through initial operational sequencing by a page key input for the wireless transmission base and receiver, and verified by LED and audible annunciator feedback; and
whereby base and receiver processors provide at least four operational controller modes.

10. A method of installing and using a wireless telephone system, the method comprising the steps:
a. providing the system of claim 9;
b. installing rechargeable battery packs into each respective unit;
c. charging each unit's battery packs for a 15 hour period using AC adapters;
d. pressing and holding the page key in the receiver unit until the receiver unit in-use LED indicator light is on;
e. pressing and holding the page key in the transmitter unit until the transmitter unit in-use LED indicator light is on an a search is underway;
f. establishing registration between transmitter and receiver when both receiver and transmitter unit LED lights are off and an audible beep sound is detected;
g. repeating the registration process for each receiver unit until all receiver units are registered with the transmitter unit;
h. connecting the transmitter unit to a telephone line jack;
i. connecting each receiver unit to a separate corded telephone;
j. for outgoing telephone communication, picking up a telephone and noticing the receiver and transmitter units LED lights are on indicating the automatic connection between the units and a dial tone is detected, placing the call and commencing telephone communication using the wireless system;
k. for incoming telephone communication, noticing an audible ring on the receiver and lighting of receiver and transmitter unit LED lights indicating the automatic connection between units, picking up the telephone to receive the communication and responding thereto using the wireless system; and
l. connecting the transmitter unit and each receiver unit to AC with AC adapters to recharge the DC battery packs when unit LED lights blink indicating a recharge is necessary.
